(19) United States
(12) Patent Application Publication
(10) Pub. No.: US 2015/0329420 A1
(43) Pub. Date: Nov. 19, 2015

(54) METHOD FOR FORMING VIA HOLE IN GLASS SUBSTRATE BY LASER IRRADIATION

(71) Applicant: ASAHI GLASS COMPANY, LIMITED, Tokyo (JP)

(72) Inventors: Kentaro TATSUKOSHI, Tokyo (JP); Yuji Notsu, Tokyo (JP); Kohei Horiuchi, Tokyo (JP)

(73) Assignee: ASAHI GLASS COMPANY, LIMITED, Tokyo (JP)

(21) Appl. No.: 14/281,259

(22) Filed: May 19, 2014

(51) Int. Cl. C03C 23/00; B23K 26/36

(52) U.S. Cl. CPC C03C 23/0025; B23K 26/365

(57) ABSTRACT

A method for forming a through-hole in a glass substrate includes the steps of (a) radiating a laser beam to a glass substrate, so that a through-hole penetrating the glass substrate from a first surface to a second surface is formed in a radiation area of the glass substrate, and a constricted part is formed in the through-hole, and (b) causing a discharge via the through-hole by applying a direct-current voltage between the first and second surfaces of the glass substrate, so that a diameter of a cross section of the constricted part that is substantially orthogonal to a longitudinal axis of the through-hole is increased.

### TECHNICAL FIELD

The present invention generally relates to a method for forming a through-hole in a glass substrate, particularly, a method for forming a through-hole in a glass substrate by laser radiation.

### BACKGROUND ART

Conventionally, there is a known technology of forming one or more fine-sized through-holes (vias) in a predetermined area of a glass substrate (see, for example, Patent Document 1)

Patent Document 1: U.S. Pat. No. 5,493,096

### DISCLOSURE OF THE INVENTION

### Problem to be Solved by Invention

Various methods for forming through-holes in a glass substrate by laser radiation have been proposed in the past.

However, the through-hole formed by the conventional method has a projecting part (hereinafter also referred to as “constricted part”) that is formed in the vicinity of an opening on a side from which a laser is radiated. An opening at the constricted part of the through-hole has a cross section (orthogonal to a longitudinal axis of the through-hole) that is smaller than a cross section of an opening at a part of the through-hole adjacent to the constricted part.

The constricted part may be a problem in a case where a glass substrate including the through-hole is used for, for example, an interposer having a through-electrode. That is, in a case where an interposer is manufactured from a glass substrate including the through-hole, a conductive material is to fill inside the through-hole. However, in a case where the constricted part exists inside the through-hole, the existence of the constricted part may prevent the conductive material from moving inside the through-hole when supplying the conductive material into the through-hole. As a result, the conductive material may be unable to sufficiently fill the entire through-hole.

This problem not only applies to a case of manufacturing an interposer including a through-electrode but may also apply to a case of filling the through-hole of the glass substrate with a given filling material.

Thus, there is a demand for a through-hole foisting method that can prevent the formation of the constricted part or sufficiently reduce the projecting amount of the constricted part.

An embodiment of the present invention is aimed to solve the above-described problem. An embodiment of the present invention is aimed to provide a method that prevents large constricted parts (as those of the conventional art) from being formed in the through-hole in a case of forming the through-hole in a glass substrate by laser radiation.

### Means for Solving Problem

According to an embodiment of the present invention, there is provided a method for forming a through-hole in a glass substrate, the method including the steps of: (a) radiating a laser beam to a glass substrate, so that a through-hole penetrating the glass substrate from a first surface to a second surface is formed in a radiation area of the glass substrate, and a constricted part is formed in the through-hole; and (b) causing a discharge via the through-hole by applying a direct-current voltage between the first and second surfaces of the glass substrate, so that a diameter of a cross section of the constricted part that is substantially orthogonal to a longitudinal axis of the through-hole is increased.

According to an embodiment of the present invention, the step (b) may be performed within a maximum of 500 μs after the step (a).

According to an embodiment of the present invention, a step of (c) applying a high-frequency high voltage between the first and second surfaces of the glass substrate may be performed between the step (a) and the step (b).

### BRIEF DESCRIPTION OF THE DRAWINGS

FIG. 1 is a schematic diagram illustrating an example of a cross section of a through-hole formed by a conventional method for forming a through-hole in a glass substrate in which the cross section is parallel to a longitudinal axis of the through-hole;

FIG. 2 is a schematic diagram illustrating an example of a cross section of a through-hole formed by a method for forming a through-hole in a glass substrate according to an embodiment of the present invention in which the cross section is parallel to a longitudinal axis of the through-hole;

FIG. 3 is a flowchart of a method for forming a through-hole in a glass substrate according to an embodiment of the present invention;

FIG. 4 is a schematic diagram illustrating an example of an apparatus that may be used for a step of a method for forming a through-hole in a glass substrate according to an embodiment of the present invention illustrated in FIG. 3;

FIG. 5 is a schematic diagram illustrating an example of an apparatus that may be used for a step of a method for forming a through-hole in a glass substrate according to an embodiment of the present invention illustrated in FIG. 3;

FIG. 6 is a flowchart of a method for forming a through-hole in a glass substrate according to another embodiment of the present invention;

FIG. 7 is a schematic diagram illustrating an example of a cross section of a through-hole formed in a glass substrate according to a first comparative example; and

FIG. 8 is a schematic diagram illustrating an example of a cross section of a through-hole formed in a glass substrate according to a first working example.

### DESCRIPTION OF THE EMBODIMENTS

In the following, embodiments of the present invention will be described with reference to the accompanying drawings.

As described above, a through-hole that is formed by a conventional method, typically, has a constricted part that is formed in the vicinity of an opening on a side from which a laser is radiated. An opening at the constricted part of the through-hole has a cross section (orthogonal to a longitudinal axis of the through-hole) that is substantially smaller than a cross section of an opening at a part of the through-hole adjacent to the constricted part.

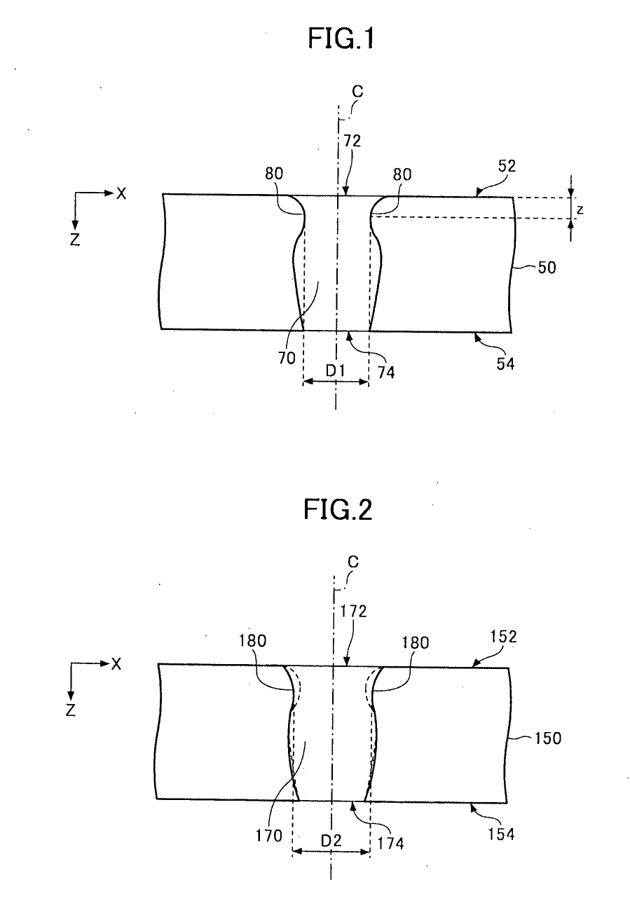

FIG. 1 is a schematic view illustrating a cross section of a through-hole including a constricted part.

As illustrated in FIG. 1, a glass substrate 50 includes a through-hole 70 penetrating the glass substrate 50 from a first surface 52 to a second surface 54. That is, the through-hole 70 includes a first opening 72 on a side of the first surface 52 of the glass substrate 50 and a second opening 74 on a side of the second surface 54 of the glass substrate 50.

Typically, in a case where the through-hole 70 is famed in the glass substrate 50 by laser radiation, a cross section of the through-hole 70 has a substantially tapered shape except for an area corresponding to the below-described constricted part 80 (see, for example, FIG. 1). That is, except for the area corresponding to the constricted part 80, the diameter of the through-hole 70 becomes smaller from a laser-incoming (incident) side (first opening 72) to a laser-outgoing side (second opening 74). However, the inclination angle of the tapered shape of the through-hole 70 becomes smaller as the glass substrate 50 becomes thinner. Therefore, in a case where the glass substrate 50 has a thickness less than, for example, approximately 0.1 mm, it may be difficult to discern the tapered shape of the through-hole 70.

As illustrated in FIG. 1, the projecting part 80 is famed in the vicinity of the first opening 72 (an area located at a distance “z” from the first opening 72 in a depth direction of the through-hole 70). An opening at an area corresponding to the constricted part 80 has a cross section (orthogonal to a longitudinal axis C of the through-hole 70) that is smaller than a cross section of an opening at an area of the through-hole 70 adjacent to the constricted part 80.

The constricted part 80 may be a problem in a case where the glass substrate 50 including the through-hole 70 is used for, for example, an interposer having a through-electrode. That is, in a case where an interposer is manufactured from the glass substrate 50 including the through-hole 70, a conductive material is to fill inside the through-hole 70. However, in a case where the constricted part 80 exists inside the through-hole 70, the existence of the constricted part 80 may prevent the conductive material from moving inside the through-hole 70 when supplying the conductive material into the through-hole 70. As a result, the conductive material may be unable to sufficiently fill the entire through-hole 70.

This problem not only applies to a case of manufacturing an interposer but may also apply to a case of filling the through-hole 70 of the glass substrate 50 with a given filling material.

On the other hand, the below-described embodiments of the present invention provides a method for forming a through-hole in a glass substrate, the method including the steps of: (a) radiating a laser beam to a glass substrate, so that a through-hole penetrating the glass substrate from a first surface to a second surface is formed in a radiation area of the glass substrate, and a constricted part is feinted in the through-hole; and (b) causing a discharge via the through-hole by applying a direct voltage between the first and second surfaces of the glass substrate, so that a diameter of a cross section of the constricted part that is substantially orthogonal to a longitudinal axis of the through-hole is increased.

With the method for forming a through-hole in a glass substrate (through-hole forming method) according to an embodiment of the present invention, a large constricted part can be prevented from being formed in the through-hole, that is, a significantly large projection can be prevented from being formed in the constricted part.

FIG. 2 is a schematic diagram illustrating a cross section of a through-hole 170 formed by the through-hole forming method according to an embodiment of the present invention. The cross section of the through-hole 170 is parallel to a longitudinal axis of the through-hole 170.

As illustrated in FIG. 2, a glass substrate 150 includes the through-hole 170 that penetrates the glass substrate 150 from a first surface 152 to a second surface 154.

The through-hole 170 includes a first opening 172 formed on an laser-incoming side (incident side) of the glass substrate 150 and a second opening 174 formed on a laser-outgoing side of the glass substrate 150. A cross section of the through-hole 150 has a substantially tapered shape except for an area corresponding to the below-described constricted part 180.

However, as illustrated in FIG. 2, the amount in which the constricted part 180 projects toward the inside of the through-hole 150 is reduced compared to that of the constricted part 80 of the through-hole 70 of FIG. 1. That is, a diameter (width) D2 of the cross section of the constricted part 180 that is orthogonal to the longitudinal axis C of the through-hole 170 is larger than a diameter (width) D1 of the cross section of the constricted part 80 that is orthogonal to the longitudinal axis V of the through-hole 70 of FIG. 1.

Therefore, with the through-hole forming method according to an embodiment of the present invention, the projecting amount of the constricted part 180 can be significantly reduced. Thus, the diameter (width) D2 of the cross section of the constricted part 180 that is orthogonal to the longitudinal axis C of the through-hole 170 can be increased.

Further, with a glass substrate having a through-hole formed by the through-hole forming method according to an embodiment of the present invention, a filling material can be relatively easily supplied into the through-hole. Thus, the filling material can appropriately fill the inside of the through-hole.

### <Method for Forming a Through-Hole in a Glass Substrate According to an Embodiment of the Present Invention>

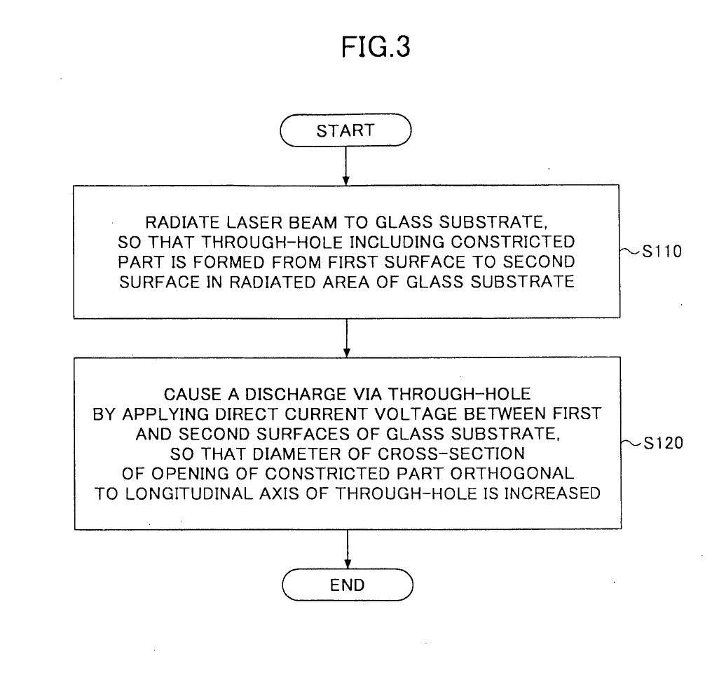

Next, a method for forming a through-hole in a glass substrate according to one embodiment of the present invention (first through-hole forming method) is described in detail with reference to FIGS. 3 to 5.

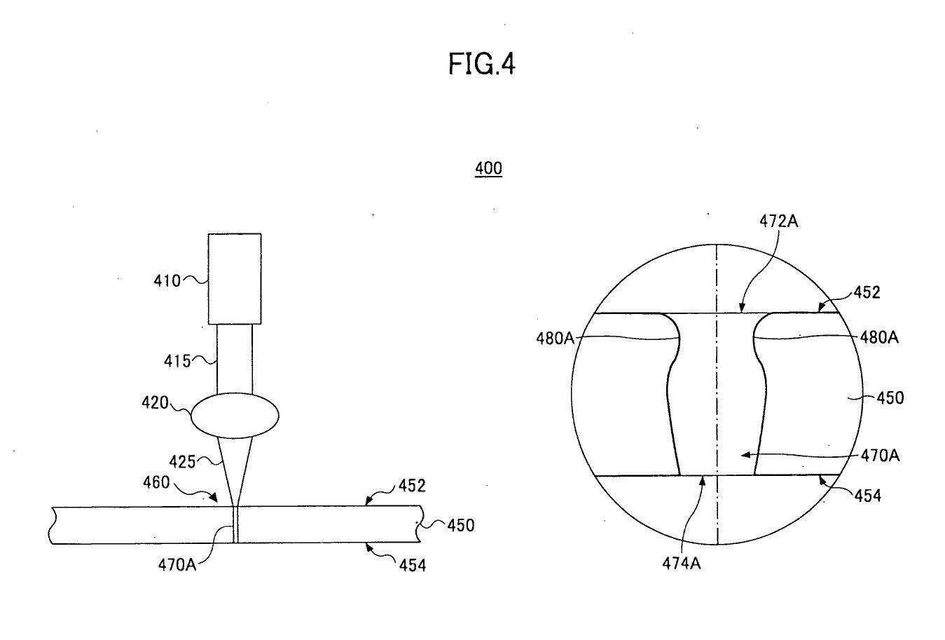

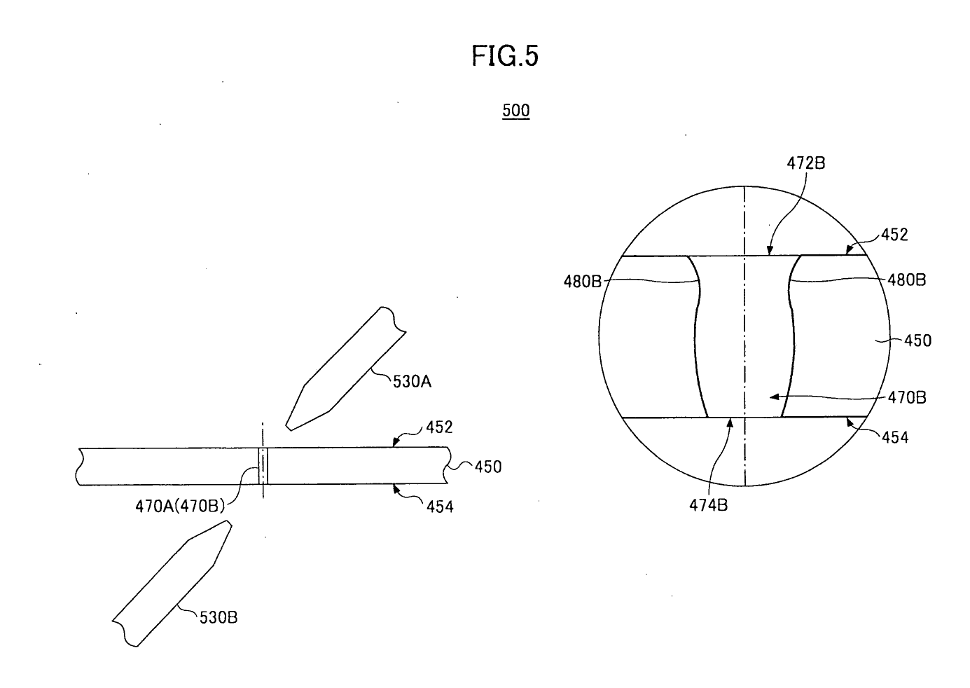

FIG. 3 is a flowchart of the first through-hole forming method. FIGS. 4 and 5 are schematic diagrams for describing an example of an apparatus used for performing the steps of the first through-hole forming method.

As illustrated in FIG. 3, the first through-hole forming method includes a step of radiating a laser beam to a glass substrate (Step S110) and a step of causing a discharge via a through-hole by applying a direct voltage between the first and second surfaces of the glass substrate (Step S120). By performing Step S110, the through-hole that penetrates the glass substrate from the first surface to the second surface is formed in a radiation area of the glass substrate, and a constricted part is formed in the through-hole. By performing Step S120, the diameter (width) of the cross section of the constricted part orthogonal to the longitudinal axis of the through-hole can be increased.

The steps of the first through-hole forming method is described in further detail.

### <Step S110>

First, a through-hole is formed in a radiation area of a glass substrate by radiating a laser beam to the glass substrate.

FIG. 4 illustrates an example of a configuration of an apparatus used for performing Step S110.

As illustrated in FIG. 4, an apparatus 400 includes a laser source 410 and a lens 420.

The laser source 410 radiates a laser beam 415 to the lens 420. The type of the laser source 410 is preferred to be a laser that enables a through-hole to be processed by heat. For example, the laser source 410 may be a CO₂ laser.

The lens 420 converges the laser beam 415, so that a converged laser beam 425 is radiated on the glass substrate 450. It is to be noted that the lens 420 is not a requisite component and may be omitted. In this case, the laser beam 415 is not converged and radiated as is on the glass substrate 450.

The glass substrate 450, which is a target process object, includes a first surface 452 and a second surface 454. The side of the first surface 542 of the glass substrate 450 corresponds to a laser radiation surface.

It is to be noted that a composition of the glass substrate 450 is not limited in particular. The glass substrate 450 may be, for example, a soda-lime glass or a alkali-free glass. Although the thickness of the glass substrate 450 is not limited in particular, the thickness of the glass substrate 450 may range, for example, from 0.05 mm to 0.70 mm.

In a case of forming a through-hole in the glass substrate 450 by using the apparatus 400, first, the laser beam 415 is radiated from the laser source 410. The laser beam 415 is converged by the lens 420 to become the converged laser beam 425. Then, the converged laser beam 425 is radiated on a radiation area 460 of the glass substrate 450.

The diameter of the beam spot of the converged laser beam 425 is not limited in particular. For example, the diameter of the beam spot of the converged laser beam 425 may range, for example, from 10 μm to 300 μm.

The radiation of the converged laser beam 425 increases the temperature at the radiation area 460 of the glass substrate 450. Thereby, the radiation area 460 of the glass substrate 450 is removed by sublimation. Thereby, a through-hole 470A is formed directly below the radiation area 460.

The through-hole 470A that is formed at this stage has a cross section having substantially the same shape as the cross section of the through-hole 70 of FIG. 1. The round circle on the right side of FIG. 4 illustrates the shape of the cross section of the through-hole 470A formed at this stage.

As illustrated in FIG. 4, the through-hole 470A includes a first opening 472A formed on a side of the first surface 452 of the glass substrate 450 and a second opening 474A formed on a side of the second surface 454 of the glass substrate 450. Further, a relatively large constricted part 480A is formed in the vicinity of the first opening 472A of the through-hole 470A.

### <Step S120>

After the through-hole 470A is formed in the substrate 150 in Step S110, a direct discharge voltage is applied between the first surface 452 and the second surface 454 of the glass substrate 450. Thereby, discharge occurs via the through-hole 470A, As a result the projection amount of the constricted part 480A in the through-hole 470A is reduced. That is, the diameter of the opening of the constricted part 480A is increased.

FIG. 5 illustrates an example of a configuration of an apparatus used for performing Step S120.

As illustrated in FIG. 5, an apparatus 500 includes a pair of electrodes 530A, 530B that is electrically connected to a direct current voltage source (not illustrated).

The electrode 530A and the electrode 530B are arranged facing each other interposed by the through-hole 470A of the glass substrate 450. More specifically, the first electrode 530A is provided in the vicinity of the through-hole 470A on the side of the first surface 452 of the glass substrate 450 whereas the second electrode 530B is provided in the vicinity of the through-hole 470A on the side of the second surface 454 of the glass substrate 450.

With the above-described arrangement, discharge occurs between the first electrode 530A and the second electrode 530B via the through-hole 470A when a direct current discharge voltage is applied between the electrode 530A and the electrode 530B.

It is to be noted that the direct current discharge voltage applied during the discharge may be range, for example, from 3000 V to 10000 V.

In a case where direct current discharge occurs via the glass substrate 450, a tip part of the constricted part 480A inside the through-hole 470A is eliminated. As a result, the through-hole 470A can be transformed to have a cross section illustrated in FIG. 2.

The round circle on the right side of FIG. 5 illustrates the shape of the cross section of the through-hole 470B formed after the direct current discharge.

As illustrated in the round circle on the right side of FIG. 5, the projection amount of the constricted part 480B of the through-hole 470B is reduced compared to that of the through-hole 470A illustrated in FIG. 4. In other words, the diameter of the cross section of the constricted part 480B orthogonal to the longitudinal axis C of the through-hole 470B can be increased compared to that of the constricted part 480A.

In a case where the through-hole 470B having the above-described shape is formed in the glass substrate 450, a filling material can be relatively easily supplied into the through-hole 470B. Thus, the filling material can appropriately fill the inside of the through-hole 470B.

For example, the diameter of the first opening 472B of the through-hole 470B after the discharge may range from 20 μm to 300 μm, and the diameter of the second opening 474B of the through-hole 470B may range from 10 μm to 300 μm.

In a case of forming multiple through-holes in the glass substrate 450, the above-described Steps S110 and S120 are repeated.

The time of the interval between Step S110 and Step S120 is not limited in particular. That is, there is no particular limit pertaining to the period starting after completing the forming of the through-hole 470A in the glass substrate 450 by radiating the converged laser beam 425 to the glass substrate 450 and ending when discharge is caused by applying direct discharge voltage to the glass substrate 450 (first discharge waiting time). However, the glass substrate 450 that is heated in Step S110 may cool if the first discharge waiting time becomes significantly long. As a result, it may be difficult to generate discharge.

For example, the first discharge waiting time is preferably 0 μs to 500 μs, and more preferably, 0 μs to 200 μs.

### <Method for Forming a Through-Hole in a Glass Substrate According to Another Embodiment of the Present Invention>

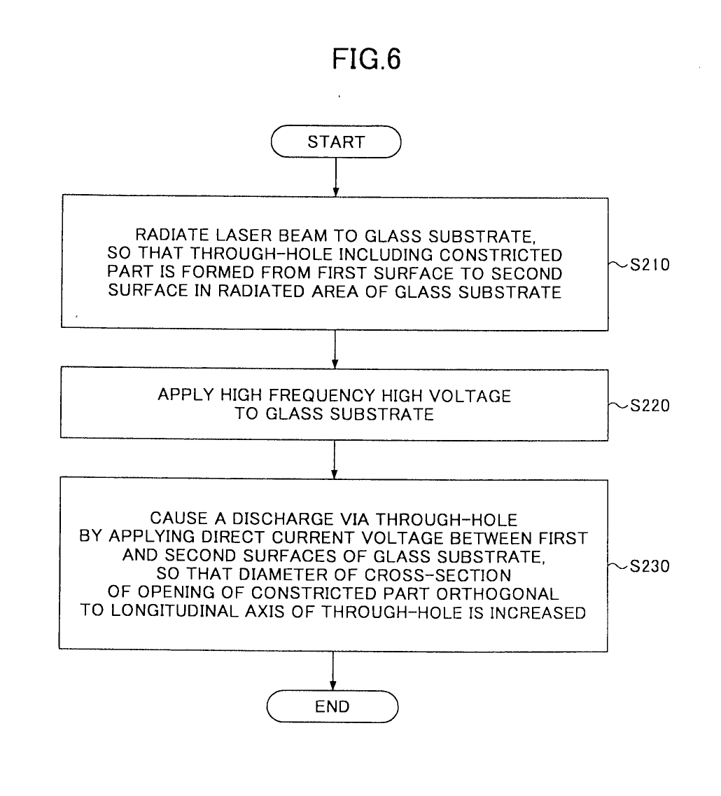

Next, a method for forming a through-hole in a glass substrate according to another embodiment of the present invention (second through-hole forming method) is described in detail with reference to FIG. 6.

FIG. 6 is a flowchart of the second through-hole forming method.

As illustrated in FIG. 6, the second through-hole forming method includes a step of radiating a laser beam to a glass substrate (Step S210), a step of applying a high-frequency high voltage to the glass substrate (Step S220), and a step of causing a discharge via a through-hole by applying a direct voltage between a first surface and a second surface of the glass substrate (Step S230). By performing Step S210, a through-hole that penetrates a glass substrate from a first surface to a second surface is formed in a radiation area of the glass substrate, and a constricted part is formed in the through-hole. By performing Step S230, the diameter (width) of the cross section of the constricted part orthogonal to the longitudinal axis of the through-hole can be increased.

Steps S210 and S230 of the second through-hole forming method of FIG. 6 are substantially the same as Steps S110 and S120 of the first through-hole forming method, respectively. Therefore, only the process of Step S220 is described in detail below. In the following description of the second through-hole forming method, like components are denoted with like reference numerals as the reference numerals used in FIGS. 4 and 5.

### <Step S220>

In the second through-hole forming method, a high-frequency high voltage is applied to the glass substrate 450 after Step S210, that is, after forming the through-hole 470A in the radiation area 460 of the glass substrate 450 by radiating the converged laser beam 4525 to the glass substrate 450.

For example, the pair of electrodes 530A, 530B of FIG. 5 may be used in a case of applying the high-frequency high voltage. In this case, as illustrated in FIG. 5, the first electrode 530A is provided in the vicinity of the through-hole 470A on the side of the first surface 452 of the glass substrate 450 whereas the second electrode 530B is provided in the vicinity of the through-hole 470A on the side of the second surface 454 of the glass substrate 450.

The frequency of the high-frequency high voltage that is applied to the glass substrate 450 may range, for example, from 100 kHz V to 100 MHz. Further, the voltage of the high-frequency high voltage applied to the glass substrate 450 may range, for example, from 100 V to 10000 V.

A plasma discharge is generated by the high-frequency high voltage to form the through-hole 470A that penetrates the glass substrate 450. Thereby a hole wall surface of the through-hole 470A is heated.

By applying the high-frequency high voltage to the glass substrate 450, an area(s) including a low resistance part in the glass substrate 450 such as through-hole 470A is partly (locally) heated.

The objective of Step S220 is to prevent the temperature of the part(s) of the through-hole 470A or the temperature of the vicinity of the through-hole 470A from decreasing until the process of Step S230 is performed on the glass substrate 450 including the through-hole 470A. That is, Step S220 is performed, so that the part of the through-hole 470A of the glass substrate 450 heated by the converged laser beam 425 can positively maintain a high temperature state until the process of Step S230 is started.

The performing of Step S220 assures that the discharging phenomenon can positively occur by applying direct current voltage in the subsequent Step S230. That is, a problem of insufficient discharge due to decrease in the temperature of the glass substrate 450 can be prevented from occurring in Step S230.

The timing for performing Step S210 and the timing for performing Step S220 are not limited in particular. That is, there is no particular limit pertaining to the period starting after completing the forming of the through-hole 470A in the glass substrate 450 by radiating the converged laser beam 425 to the glass substrate 450 and ending when applying of the high-frequency high voltage to the glass substrate 450 is started. However, the heat increase of the glass substrate 450 caused by the laser radiation cannot be maintained if the time between Step S210 and Step S220 is too long. Therefore, the time between Step S210 and Step S220 is preferred to be as short as possible. For example, the step of applying a high-frequency high voltage to the glass substrate 450 may be performed to overlap with the step of radiating the converged laser beam 425.

Similarly, the time of the interval between Step S220 and Step S230 is not limited in particular. That is, there is no particular limit pertaining to the period starting after applying a high-frequency high voltage to the glass substrate 450 and ending when discharge is caused by applying direct discharge voltage to the glass substrate 450 (second discharge waiting time). However, the glass substrate 450 that is heated in Step S220 may cool if the second discharge waiting time becomes significantly long. As a result, it may be difficult to generate discharge in Step S230.

For example, the second discharge waiting time is preferably 0 μs to 500 μs, and more preferably, 0 μs to 200 μs.

Therefore, similar to the first through-hole forming method, the second through-hole forming method of FIG. 6 can significantly increase the diameter (width) of the cross section of the constricted part 480B that is orthogonal to the longitudinal axis C of the through-hole 470B. Therefore, with the glass substrate 450 having a through-hole 470B formed by the second through-hole forming method, a filling material can be relatively easily supplied into the through-hole 470B. Thus, the filling material can appropriately fill the inside of the through-hole 470B.

### WORKING EXAMPLES

Next, working examples of the present invention are described.

### First Comparative Example

A through-hole was formed in a glass substrate by laser radiation by using the apparatus 100 illustrated in FIG. 4. The state of a constricted part in the through-hole was evaluated.

A alkali-free glass having a thickness of 0.3 mm was used as the glass substrate.

A CO₂ laser having a wavelength of 9.3 μm was used as the laser source. The laser output was 50 W, and the radiated laser beam was set with a CW waveform (ON-time of approximately 800 μs).

The diameter of the beam spot of the converged laser beam at the radiation area was approximately 70 μm.

Thereby, a through-hole having a substantially tapered shape was formed in the glass substrate in which a first opening (opening of laser-incoming side) of the through-hole was approximately 70 μm and a second opening (opening of laser-outgoing side) of the through-hole was approximately 50 μm.

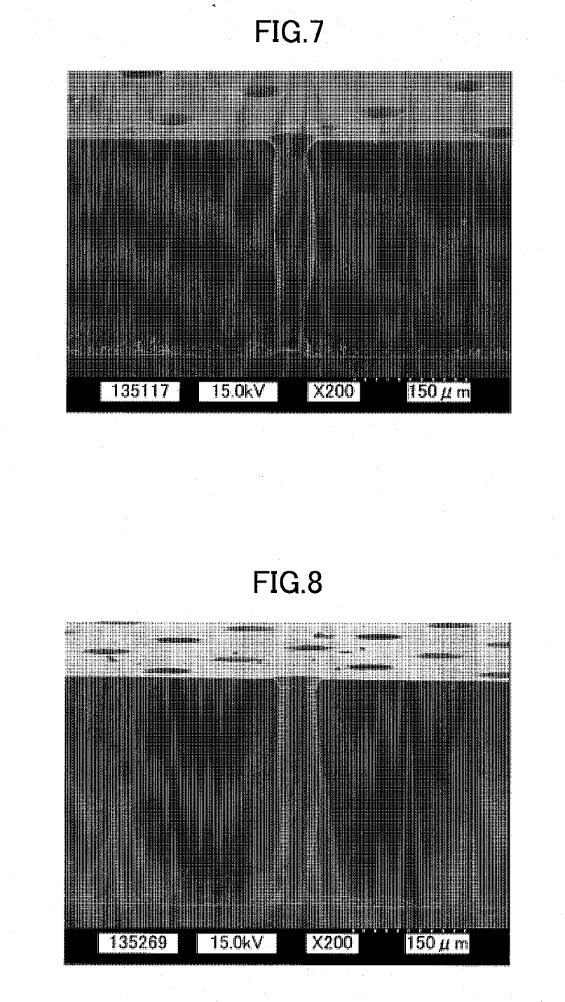

FIG. 7 illustrates an example of a cross section of the through-hole fainted in the glass substrate by laser radiation. In FIG. 7, an upper side of the glass substrate corresponds to the laser-incoming side.

According to FIG. 7, it was observed that a large constricted part is fainted in the through-hole at a position of approximately 20 μm to 30 μm deep from the first opening. At the position of the constricted part, the cross section of the constricted part orthogonal to the longitudinal axis of the through-hole was less than 40 μm, and the diameter (width) was significantly reduced due to the existence of the constricted part.

### First Working Example

A through-hole was formed in a glass substrate by laser radiation by the above-described first through-hole forming method illustrated in FIG. 3. The state of a constricted part in the through-hole was evaluated.

In the process of radiating a laser beam in Step S110, the apparatus 100 illustrated in FIG. 4 was used. The laser beam was radiated to the glass substrate under the same conditions as those of the first comparative example. Further, in the process of causing a discharge by applying a direct current discharge voltage in Step S120, a voltage of 5000 V was applied to the electrodes on both sides of the glass substrate.

The period starting from the forming of the through-hole in the glass substrate by laser radiation and ending when the discharge is caused (i.e. first discharge waiting time) was 200 μm.

Thereby, a through-hole having a substantially tapered shape was formed in the glass substrate in which a first opening (opening of laser-incoming side) of the through-hole was approximately 70 μm and a second opening (opening of laser-outgoing side) of the through-hole was approximately 50 μm.

FIG. 8 illustrates an example of a cross section of the through-hole formed in the glass substrate by laser radiation. In FIG. 8, an upper side of the glass substrate corresponds to the laser-incoming side.

According to FIG. 8, it was observed that hardly any constricted parts were formed in the through-hole.

Hence, the above-described embodiments of the present invention can be applied to, for example, a method for forming a through-hole in a glass substrate by laser radiation. With the above-described embodiments of the present invention, large constricted parts (as those of the conventional art) can be prevented from being formed in the through-hole in a case of forming the through-hole in a glass substrate by laser radiation.

The present invention may be applied to, for example, a method for forming a through-hole in a glass substrate by laser radiation.

The present application is based on Japanese Application No. 2013-091153 filed on Apr. 24, 2013, with the Japanese Patent Office, the entire contents of which are hereby incorporated by reference.

### EXPLANATION OF REFERENCE NUMERALS

50 glass substrate
52 first surface
54 second surface
70 through-hole
72 first opening
74 second opening
80 constricted part
150 glass substrate
152 first surface
154 second surface
170 through-hole
172 first opening
174 second opening
180 constricted part
400 apparatus
410 laser source
415 laser beam
420 lens
425 converged laser beam
450 glass substrate
452 first surface
454 second surface
460 radiation area
470A, 470B through-hole
472A, 472B first opening
474A, 474B second opening
480A, 480B constricted part
500 apparatus
530A, 530B electrode

1. A method for forming a through-hole in a glass substrate, the method comprising the steps of:
(a) radiating a laser beam to a glass substrate, so that a through-hole penetrating the glass substrate from a first surface to a second surface is formed in a radiation area of the glass substrate, and a constricted part is formed in the through-hole; and
(b) causing a discharge via the through-hole by applying a direct-current voltage between the first and second surfaces of the glass substrate, so that a diameter of a cross section of the constricted part that is substantially orthogonal to a longitudinal axis of the through-hole is increased.

2. The method as claimed in claim 1,
wherein the step (b) is performed within a maximum of 500 μs after the step (a).

3. The method as claimed in claim 1, wherein a step of (c) applying a high-frequency high voltage between the first and second surfaces of the glass substrate is performed between the step (a) and the step (b).
